(19) United States
(12) Patent Application Publication
(10) Pub. No.: US 2001/0030971 A1
(43) Pub. Date: Oct. 18, 2001

(54) Parallel interconnect implemented with hardware

(76) Inventor: Francis A. Moody, Baltimore, MD (US)

Correspondence Address: Brett G. Alten, Esq., YAFO Networks, Inc., 1340 F Charwood Road, Hanover, MD, 21076, US

(21) Appl. No.: 09/754,548

(22) Filed: Jan. 5, 2001

Related U.S. Application Data
(60) Provisional application No. 60/174,598, filed on Jan. 5, 2000.

(51) Int. Cl. H04J 3/06; H04J 3/16

(52) U.S. Cl. 370/401; 370/463; 370/466; 370/476; 370/514; 714/752

(57) ABSTRACT

A router interface that increases the data transmission rate between optical data routers is provided. In particular, a parallel router interface according to this invention includes: (1) a plurality of parallel channels, (2) a parallel-to-serial converter, and (3) a plurality of framers. Each of the channels can transmit a block of bits at a time, and each block forms at least a portion of a packet. The parallel-to-serial converter converts each of the blocks to a serial stream of data and provides the stream to a serial interface. The plurality of framers are coupled to the serial interface and are each associated with one of the parallel channels.

### CROSS-REFERENCE TO RELATED APPLICATIONS

This claims priority under 35 U.S.C. 119(e)(1) to U.S. Provisional Patent Application No. 60/174,598, filed Jan. 5, 2000, which is hereby incorporated by reference in its entirety.

### FIELD OF THE INVENTION

The present invention relates to methods and apparatus for increasing the data transmission rate between optical data routers, and more particularly to parallel interconnecting hardware for such routers.

### BACKGROUND OF THE INVENTION

An optical router determines the best path for a data packet to be sent from one optical network to another. Generally, a router stores and forwards electronic information between optical networks, first determining all possible paths to a destination address and then picking the most expedient route, based on the traffic load and the number of hops required. Routers can be constructed from either hardware or a combination of hardware and software.

FIG. 1 shows conventional communication system 100 including a connection between two routers 105 and 110. Router 105 delivers data in packet form to interface 107 (e.g., a 10 Gbps interface). Interface 107 then supplies the data to port 109 of wavelength division multiplexing (hereinafter, “WDM”) multiplexer 111. Multiplexer 111 multiplexes an optical signal and supplies the signal to optical fiber 115. Fiber 115 supplies the signal to WDM demultiplexer 120, which demultiplexes the multiplexed optical signal into a plurality of single wavelength signals. Each of the demultiplexed signals are then output via port card 121 to interface 122 of router 110.

One way to increase the speed requirements of communications system 100 is to increase the bit rates of the interfaces. For example, when a 20 Gbps transmission rate is desired, the system shown in FIG. 1 can be modified by replacing the 10 Gbps interfaces with 20 Gbps interfaces. There is an upper limit, however, on these bit rates, both for the interfaces and for the fibers connecting the routers.

FIG. 2 shows another way of increasing the speed requirements of a communications system. Communication system 200 increases the capacity of a router by replacing each interface (e.g., interface 107 of FIG. 1) that has less than the desired capacity with multiple interfaces. In this way, the combination of interfaces can have a total capacity equal to or greater than that of the desired capacity.

For example, communication system 200 includes a connection between two routers 205 and 210. If a 20 Gbps transmission rate were desired, each of routers 205 and 210 could include two 10 Gbps interfaces. Router 205 delivers data in packet form to interfaces 207 and 208 (e.g., 10 Gbps interfaces). Interfaces 207 and 208 then supply the data to ports 209 and 210 of wavelength division multiplexing (hereinafter, “WDM”) multiplexer 211. Multiplexer 211 multiplexes an optical signal and supplies the signal via port cards 221 and 223 to optical fiber 215. Fiber 215 supplies the signal to WDM demultiplexer 220, which demultiplexes the multiplexed optical signal into a plurality of single wavelength signals. Each of the demultiplexed signals are then output to interfaces 222 and 224 of router 210.

Such a configuration, however, requires complicated software modifications to the programs in the router because the routers must now “load-share” between the interfaces. So, additional load-sharing modules 206 and 216 are therefore required in routers 205 and 210. Load-share modules 206 and 216 determine how packets are allocated between interfaces. This determination can be performed either by software or a combination of software and hardware, but in either case software algorithms are required. These algorithms, however, are generally massively complex because packets are not of a uniform size and slow because of processing speed limitations. Thus, load-sharing can be difficult to design and control.

It would therefore be desirable to provide a high-speed communication system with router interfaces that are capable of operating at high bit rates.

It would also be desirable to provide a high-speed communication system with router interfaces that are easy to build and are not limited by computer processing speeds.

### SUMMARY OF THE INVENTION

It is therefore an object of this invention to provide a high-speed communication system with a router interface that is capable of operating at high bit rates.

It is also an object of this invention to provide a high-speed communication system with router interfaces that are easy to build and are not limited by computer processing speeds.

In accordance with this invention, a router interface that increases the data transmission rate between optical data routers is provided. In particular, a parallel router interface includes: (1) a plurality of parallel channels, (2) a parallel-to-serial converter, and (3) a plurality of framers. Each of the channels can transmit a block of bits at a time, and each block forms at least a portion of a packet. The parallel-to-serial converter converts each of the blocks to a serial stream of data and provides the stream to a serial interface. The plurality of framers are coupled to the serial interface and are each associated with one of the parallel channels.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which

FIG. 1 shows a schematic representation of a 10 Gbps interconnect configuration between two remote routers;

FIG. 2 shows a schematic representation of a 20 Gbps interconnect configuration between two remote routers;

FIG. 3 shows a schematic representation of an illustrative 80 Gbps parallel interconnect configuration according to this invention;

FIG. 4 shows an illustrative transmitter according to this invention; and

FIG. 5 shows an illustrative receiver according to this invention.

### DETAILED DESCRIPTION OF THE INVENTION

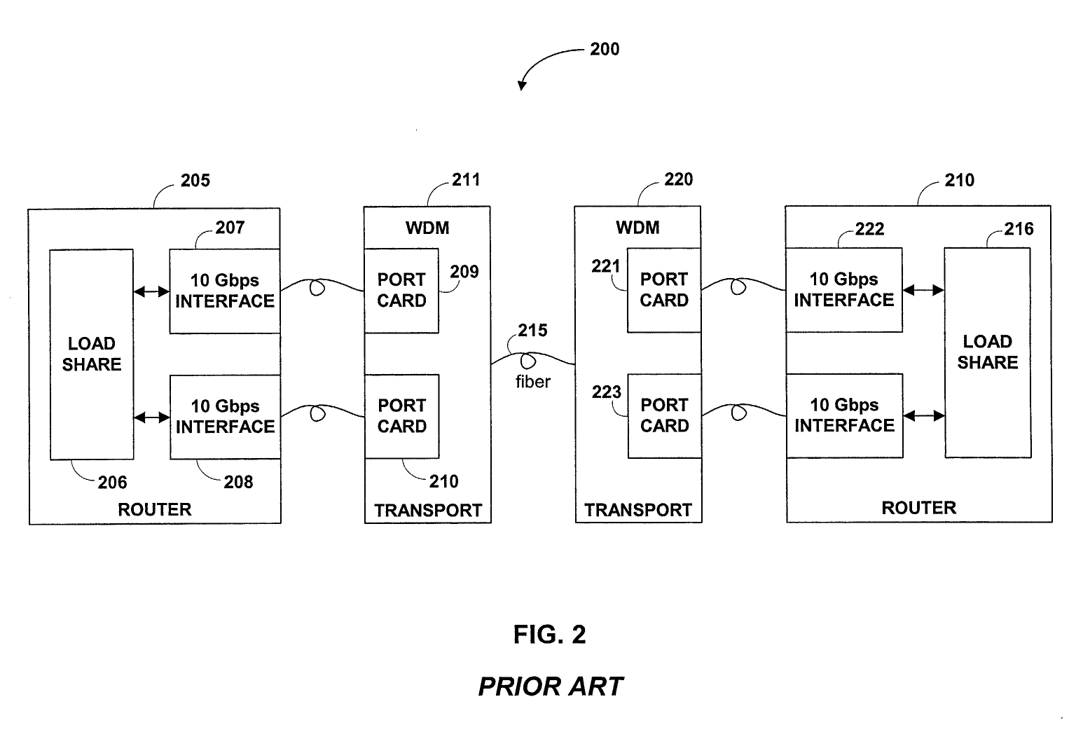

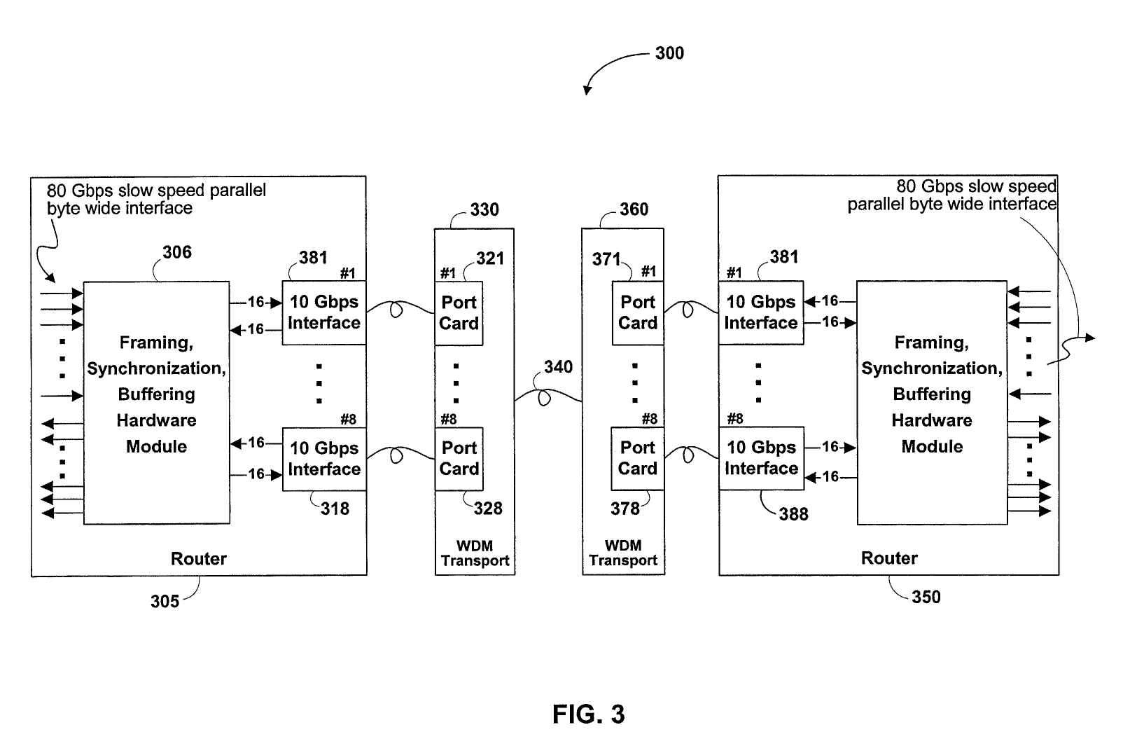

FIG. 3 is an illustrative communication system in accordance with the present invention. Like system 200 of FIG. 2, respectively, system 300 of FIG. 3 increases the capacity of a router by replacing each interface that has less than the desired capacity with multiple interfaces. In this way, the combination of interfaces can have a total capacity equal to or greater than that of the desired capacity. In contrast to the routers shown in FIG. 2, no load-sharing is required.

Communication system 300 includes a connection between two routers 305 and 350. If an 80 Gbps transmission rate were desired, each of routers 305 and 350 could include eight 10 Gbps interfaces. Router 305 delivers data in packet form to interfaces 311, . . . , 318 (e.g., 10 Gbps interfaces) via hardware module 306. In this case, routers 305 and 350 do not determine the load-sharing through software. Rather, hardware module 306 processes the data such that the data looks the same to the router as a single interface of the desired capacity. In the example shown in FIG. 3, the desired speed is 80 Gbps, and there are eight 10 Gbps interfaces. Details of how a hardware module works in accordance with this invention is described more fully below.

Hardware module 306 delivers the data to ports 321, . . . , 328 of wavelength division multiplexing (hereinafter, “WDM”) multiplexer 330, which multiplexes an optical signal and supplies it to optical fiber 340. Fiber 340 supplies the signal to WDM demultiplexer 360, which demultiplexes the multiplexed optical signal into a plurality of single wavelength signals using conventional techniques. Each of the demultiplexed signals are then output from ports 371, . . . , 378 to interfaces 381, . . . , 388 of router 350.

It will be appreciated that for the purpose of simplicity, only the first and last interfaces and ports are shown in FIG. 3. It will be further appreciated that the number and speed of the interfaces and ports is a design choice and can be greater than or less than the eight 10 Gbps units described herein.

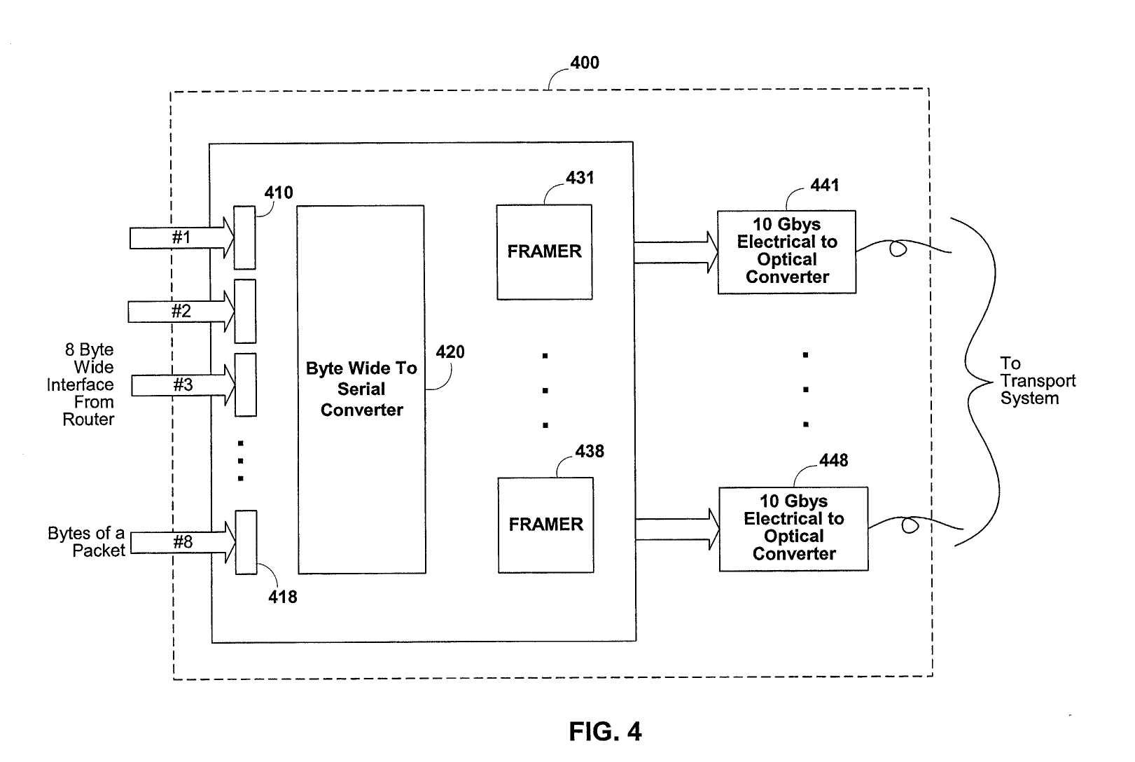

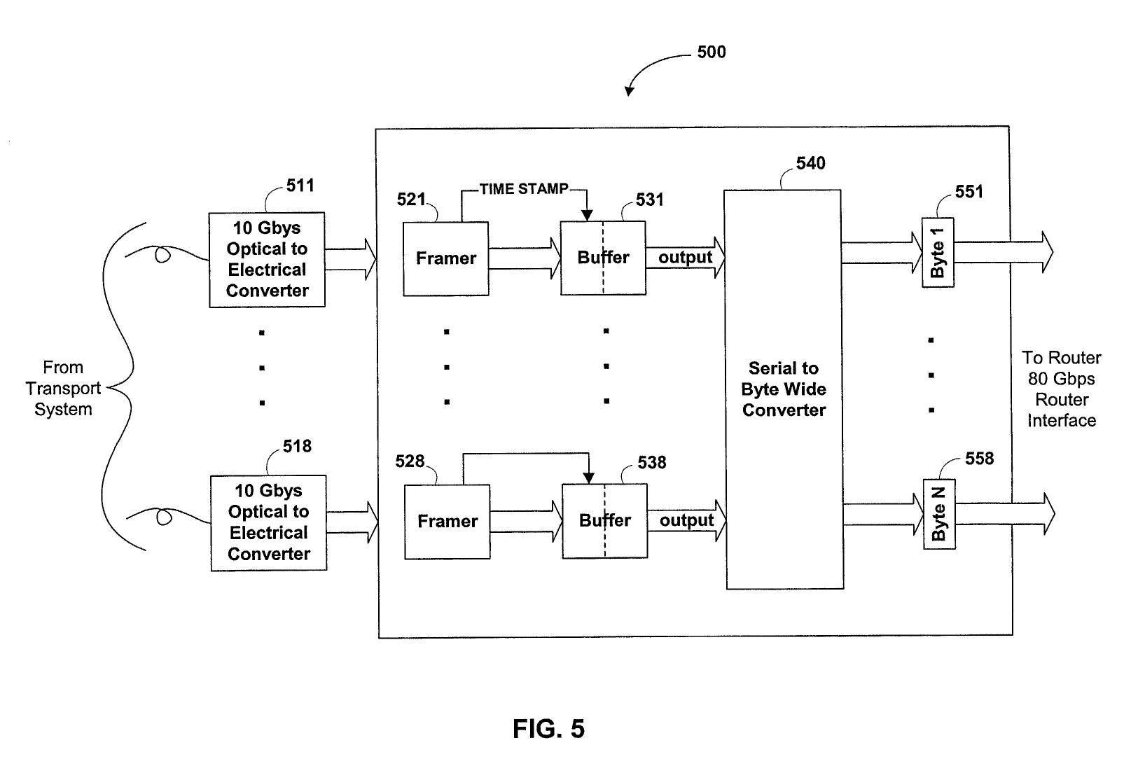

FIG. 4 shows an illustrative hardware module for a transmitter (a similar hardware module is also shown in FIG. 5). Hardware module 400 acts as a multi-byte wide parallel router interface, which, as explained above, transmits a number of blocks of bits at a time by means of multiple parallel channels 411, . . . , 418. As used herein, a parallel interface can transmit, for example, multiple bytes at one time across multiple channels, respectively, and can either be uni- or bi-directional. These channels can also be used for addressing, error correction, and other control signals. Additional channels can be used.

During operation, module 400 receives the data in packet form from a router along a multiple block (e.g., an “n” byte) interface in a manner similar to a conventional single byte interface. The number of block interfaces is a design choice. If the number of block interfaces, and hence framers, is different than eight, the data from each block interface can be distributed evenly, or at least substantially evenly. This could mean, for example, that the difference in data load between the interfaces does not exceed a particular limit, such as 1 bit. It will therefore be appreciated that a block can include any convenient number of bits according to this invention.

As used herein, a packet can contain data as well as addresses, error checking, and other information necessary to ensure that the packet arrives intact at its intended destination. The “byte wide” interface is then converted from a plurality of parallel blocks into a series of blocks using parallel-to-serial converter 420. According to one embodiment of this invention, each channel can be allocated a fixed time duration or slot during conversion. Then, in theory, the speed of the high speed serial line should be at least equal to the total of the speeds of the slower speed lines coming into the converter.

The series of blocks generated by converter 420 and delivered to each of respective framers 431, . . . , 438. A serial-to-parallel converter (e.g., converter 540 of FIG. 5) at the other end of the network then converts the data stream to the original parallel format, presenting one bit, character, or more generally block, to each lower speed channel just as they originated.

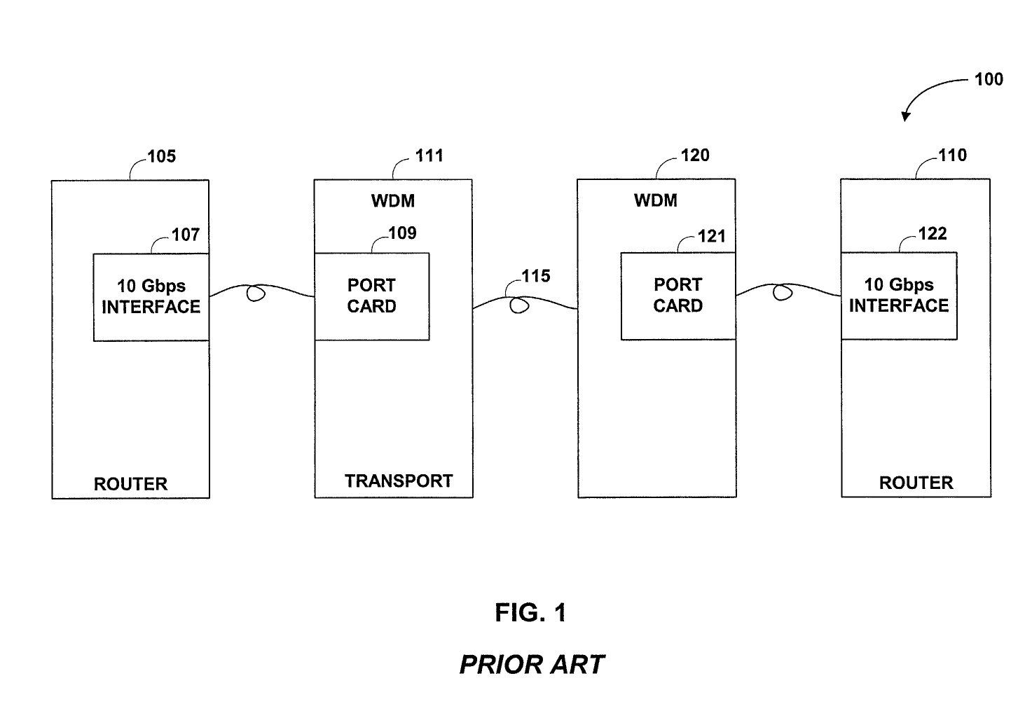

According to one aspect of this invention, framers 431, . . . , 438 can add the synchronization word at the same time to serve as a temporal marker. During operation, data supplied by framers 431, . . . , 438 can be output to electrical-to-optical converters 441, . . . , 448. Converters 441, . . . , 448 then deliver their respective optical signals to a corresponding number of ports in a WDM multiplexer (not shown). As already described with respect to FIGS. 1-3, the multiplexer transmits the multiplexed signal along an optical fiber network to a WDM demultiplexer, which supplies a demultiplexed signal to respective optical-electrical interfaces of a receiver.

Framers can be any combination of hardware and software that can be used to convert communications packets from formats like TCP, SNA, IPX, and others into frames that can then be sent over any frame relay network. A framer can thus provide time synchronization between at least two interfaces, such as by adding a synchronization word to the payload. A framer can also add an error detect code and a forward error correction, if desired. Framers can further be used to scramble the payload.

FIG. 5 shows an illustrative embodiment of a hardware module for a receiver according to this invention. As mentioned above, receiver module 500 is similar to transmitter module 400, except that module 500 essentially works in the opposite direction and can further include buffer and time stamping functions for reconstructing the signal originally received by the transmitter before being transported across the network. Thus, optical signals are provided to module 500 through optical-to-electrical converters 511, . . . , 518. The individual electrical signals are then respectively sent to framers 521, . . . , 528, and buffers 531, . . . , 538. These buffers can be configured to store the received data until a time stamp triggers the release of the data to serial-to-parallel (e.g., serial-to-byte-wide) converter 540. Buffers 531, . . . , 538 are preferably sufficiently large to accommodate the largest possible delay between the parallel channels 551, . . . , 558. The data can be output by the buffers once the time stamp indicates that all of the original synchronization words are aligned, thereby compensating for the delay between the channels.

In addition to adding synchronization, framers 521, . . . , 528 in the receiver can also detect errors in the payload, unscramble the payload, and correct the payload in accordance with the capabilities of any forward error correction methods. The serial data can be then converted back into the byte wide word data in the reverse manner of the transmitter, and this data can be output to the router. In this way, a router effectively sees an 80 Gbps interface with no further burdens placed on the router.

Thus it is seen that a parallel router interface that increases the data transmission rate between optical data routers is provided. One skilled in the art will appreciate that the present invention can be practiced by other than the described embodiments, which are presented for purposes of illustration and not of limitation. It will be further appreciated that the present invention is limited only by the claims that follow.

What is claimed is:

1. A parallel router interface comprising:
a plurality of parallel channels, wherein each of said channels can transmit a block of bits at a time, and wherein said blocks form at least a portion of a packet;
a parallel-to-serial converter that converts each of said blocks to a serial stream of data and provides said stream to a serial interface; and
a plurality of framers coupled to said serial interface, wherein each of said framers is associated with one of said plurality of parallel channels.

2. The interface of claim 1 wherein each of said blocks is at least a byte wide, and wherein each of said parallel channels has at least a byte-wide interface for grabbing said block of data.

3. The interface of claim 1 for transmitting at least 80 Gbps/sec wherein each said at least a byte-wide interface is exactly a byte wide and said plurality of parallel channels comprises eight byte-wide channels for transmitting data at a rate of at least 10 Gbps each.

4. The interface of claim 1 wherein each of said blocks is a half byte wide, and wherein each of said parallel channels has at least a half byte wide interface for grabbing said block of data.

5. The interface of claim 1 for transmitting at least 80 Gbps wherein each said at least a half byte-wide interface is exactly a half byte wide and said plurality of parallel channels comprises thirty two half byte-wide channels for transmitting data at a rate of at least 2.4 Gbps each.

6. The interface of claim 1 wherein each of said plurality of framers add a synchronization word at a same time that serves as a temporal marker.

7. The interface of claim 1 wherein each of said framers is a combination of hardware and software.

8. The interface of claim 1 wherein each of said framers converts communications packets from at least one format selected from a group selected from TCP, SNA, IPX, into frames that can be sent over a frame relay network.

9. The interface of claim 1 wherein each of said framers provides time synchronization between at least two of said channels by adding a synchronization word.

10. The interface of claim 9 wherein each of said framers provides at least one of an error detection code and a forward error correction.

11. The interface of claim 9 wherein each of said framers scrambles packet data.

12. A hardware-based router interface between a router having a desired capacity and at least two lower-capacity interfaces, wherein each of said lower-capacity interfaces comprises:
a plurality of block interfaces that each handle a block of a packet at a time;
a framer for each of said lower-capacity interfaces, wherein each of said framers provides time synchronization between said lower-capacity interfaces; and
a converter that supplies data between said lower-capacity interfaces and said framers.

14. The router interface of claim 12 wherein said block interfaces are byte-wide interfaces.

15. A system comprising:
a first router and a second router of a desired capacity, each router including a hardware interface between the router and at least two lower-capacity interfaces of less than the desired capacity, the hardware interface comprising:
a plurality of block interfaces, wherein each of said block interfaces can transmit a byte of a packet at a time;
a plurality of respective framers for each of said at lower-capacity interfaces, each of said framer providing time synchronization between said at least two interfaces; and
at least one converter that supplies data between said plurality of block interfaces and said framers; and
a WDM transport system between said routers.

16. The system of claim 15 wherein said block interfaces are byte-wide interfaces.
